(19) United States
(12) Patent Application Publication
(10) Pub. No.: US 2024/0419993 A1
(43) Pub. Date: Dec. 19, 2024

(54) INFORMATION PROCESSING DEVICE

(71) Applicant: Mitsubishi Electric Corporation, Tokyo (JP)

(72) Inventors: Yusuke YAMAKAJI, Tokyo (JP); Kunihiko FUKUSHIMA, Tokyo (JP)

(73) Assignee: Mitsubishi Electric Corporation, Tokyo (JP)

(21) Appl. No.: 18/819,910

(22) Filed: Aug. 29, 2024

Related U.S. Application Data
(63) Continuation of application No. PCT/JP2022/014204, filed on Mar. 25, 2022.

(51) Int. Cl. G06N 5/04; G06N 20/00

(52) U.S. Cl. CPC G06N 5/04; G06N 20/00

(57) ABSTRACT

Included are: a feature value extracting unit that extracts a feature value of input data; a similar data classifying unit that classifies, on the basis of a first dataset including a plurality of pieces of input data and the feature value extracted by the feature value extracting unit for each of the plurality of pieces of input data included in the first dataset, a plurality of pieces of input data having similar feature values as a second dataset among the plurality of pieces of input data included in the first dataset; and a model generating unit that generates a first trained model, which is a trained model for classifying input data, using the second dataset.

### CROSS REFERENCE TO RELATED APPLICATION

This application is a Continuation of PCT International Application No. PCT/JP2022/014204, filed on Mar. 25, 2022, which is hereby expressly incorporated by reference into the present application.

### TECHNICAL FIELD

The present disclosure relates to an information processing device.

### BACKGROUND ART

Conventionally, a neural network used for recognition of an image, a moving image, a graph, or the like causes an information processing device to learn data of each domain and extracts a feature value in the data. As one means for extracting a feature value, a convolutional neural network (CNN) that can obtain high recognition performance using convolution calculation in deep learning is known. In addition, as another means for extracting a feature value, a neural network utilizing a transformer which is an application of ATTENTION (selective attention) and called a vision transformer network (ViT) is known in a case of an image, and a neural network utilizing the transformer and called a graph transformer network is known in a case of a graph. At this time, in a case of a task of classifying data in any method, a probability for each classification is output, and data with the highest probability is output. In particular, a method for not outputting data with a low probability is known (for example, Patent Literature 1).

### CITATION LIST

### Patent Literature

Patent Literature 1: JP 2013-117861 A

### SUMMARY OF INVENTION

### Technical Problem

In general, in an information processing device that performs training using a dataset in which a correct answer label is given to each piece of input data as in the above information processing device, there is a case where a training result is affected by an error in the correct answer label, and inference accuracy decreases.

The present disclosure has solved the above problems, and an object of the present disclosure is to provide an information processing device and an information processing method capable of improving inference accuracy.

### Solution to Problem

An information processing device according to the present disclosure includes: a processor; and a memory storing a program, upon executed by the processor, to perform a process: to extract a feature value of input data; to classify, on a basis of a first dataset including a plurality of pieces of input data and the feature value extracted for each of the plurality of pieces of input data included in the first dataset, some or all of the plurality of pieces of input data included in the first dataset into N datasets including a plurality of pieces of input data having similar feature values and to newly give N different labels to the respective N datasets, in which N represents a specific integer of two or more; to generate, using a part of each of the N datasets, a trained model for classifying input data in such a manner as to correspond to any one of labels given to the respective N datasets; and to classify input data by inference based on a trained model generated, wherein the process defines a fifth dataset including N correct answer labels on a basis of inference accuracy when the process classifies, by inference based on the trained model generated, input data not used for generation of the trained model among the N datasets.

### Advantageous Effects of Invention

The present disclosure has the above configuration, and therefore can improve inference accuracy.

### BRIEF DESCRIPTION OF DRAWINGS

FIG. 1 is a diagram illustrating an example of a hardware configuration of an information processing device according to a first embodiment.

FIG. 2 is a block diagram illustrating a configuration of the information processing device according to the first embodiment.

FIG. 3 is a flowchart illustrating clustering processing performed by the information processing device according to the first embodiment.

FIG. 4 is a schematic diagram illustrating clustering processing performed by the information processing device according to the first embodiment.

FIG. 5 is a diagram illustrating an example of a dataset of an image input to the information processing device according to the first embodiment.

FIG. 6 is a diagram illustrating an example of a dataset of a graph input to the information processing device according to the first embodiment.

FIG. 7 is a diagram illustrating an example of a dataset of a natural language input to the information processing device according to the first embodiment.

FIG. 8 is a diagram illustrating an example of a dataset of a time waveform of a signal input to the information processing device according to the first embodiment.

FIG. 9 is experimental data illustrating inference accuracy for test data of the information processing device according to the first embodiment.

FIG. 10 is a flowchart illustrating training processing performed by an information processing device according to a second embodiment.

FIG. 11 is a flowchart illustrating training processing performed by the information processing device according to the second embodiment.

FIG. 12 is a flowchart illustrating training processing performed by the information processing device according to the second embodiment.

FIG. 13 is a flowchart illustrating training processing performed by the information processing device according to the second embodiment.

FIG. 14 is experimental data illustrating inference accuracy for test data of the information processing device according to the second embodiment.

FIG. 15 is a flowchart illustrating training processing performed by an information processing device according to a third embodiment.

FIG. 16 is a flowchart illustrating training processing performed by the information processing device according to the third embodiment.

FIG. 17 is experimental data illustrating inference accuracy for test data of the information processing device according to the third embodiment.

FIG. 18 is a flowchart illustrating training processing performed by the information processing device according to the third embodiment.

FIG. 19 is a block diagram illustrating a configuration of an information processing device according to a fourth embodiment.

FIG. 20 is a flowchart illustrating training processing performed by the information processing device according to the fourth embodiment.

FIG. 21 is a flowchart illustrating training processing performed by the information processing device according to the fourth embodiment.

FIG. 22 is a flowchart illustrating training processing performed by an information processing device according to a fifth embodiment.

### DESCRIPTION OF EMBODIMENTS

Hereinafter, embodiments according to the present disclosure will be described in detail with reference to the drawings.

### First Embodiment

### <Configuration of Hardware>

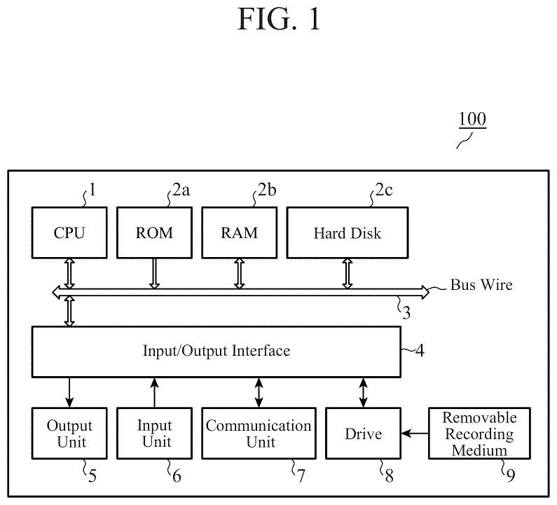

FIG. 1 is a diagram illustrating an example of a configuration of hardware as an information processing device 100 according to a first embodiment of the present application. The hardware as the information processing device 100 may be a stand-alone computer not connected to an information network, or may be a server or a client of a server client system connected to a cloud or the like via an information network. Furthermore, the hardware may be a smartphone or a microcomputer. In addition, in a case where it is assumed that the hardware is in a factory or the like, the hardware may be a computer environment in a network closed in the factory, which is called edge computing.

The information processing device 100 incorporates a central processing unit (CPU) 1, and an input/output interface 4 is connected to the CPU 1 via a bus wire. When a command is input through the input/output interface 4 by a user who uses machine learning operating an input unit 6 or the like, the CPU 1 executes a program stored in a read only memory (ROM) 2a in response to the command. Alternatively, the CPU 1 loads a program stored in a hard disk (HDD) 2c or a solid state drive (SSD, not illustrated) into a random access memory (RAM) 2b, reads and writes the program as necessary, and executes the program. As a result, the CPU 1 performs various types of processing and causes the information processing device 100 to function as a device having a predetermined function.

The CPU 1 outputs results of various types of processing from an output device that is an output unit 5 or transmits the results from a communication device that is a communication unit 7 via the input/output interface 4, or records the results in the hard disk 2c as necessary. In addition, the CPU 1 receives various types of information from the communication unit 7 via the input/output interface 4 or calls the information from the hard disk 2c as necessary, and uses the information.

The input unit 6 is constituted by a keyboard, a mouse, a microphone, a camera, or the like. The output unit 5 is constituted by a liquid crystal display (LCD), a speaker, or the like. A program executed by the CPU 1 can be recorded in advance in the hard disk 2c or the ROM 2a as a recording medium built in the information processing device 100. Alternatively, the program and a dataset can be stored (recorded) in a removable recording medium 9 connected via a drive 8.

Such a removable recording medium 9 can be provided as so-called package software. Examples of the removable recording medium 9 include a flexible disc, a compact disc read only memory (CD-ROM), a magneto optical (MO) disc, a digital versatile disc (DVD), a magnetic disc, and a semiconductor memory.

In addition, the program and the dataset can be transmitted and received through a system (Com port) in which a plurality of pieces of hardware are connected to each other by wired and/or wireless connection, such as World Wide Web (WWW). Furthermore, training described later is performed, and only a weighting function obtained by training can be transmitted and received by the above method.

For example, the CPU 1 causes the information processing device 100 to function as a machine learning device that performs calculation processing of machine learning. Note that the machine learning device can be constituted by general-purpose hardware that excels in parallel calculation, such as a CPU or a graphics processing unit (GPU), or can be constituted by dedicated hardware such as a field-programmable gate array (FPGA) or an application specific integrated circuit (ASIC).

Furthermore, the information processing device 100 may be constituted by a plurality of information processing devices via a communication port, or may be implemented by hardware in which training and inference described later have different configurations. Furthermore, the information processing device 100 may receive a sensor signal connected to different pieces of hardware via a communication port, or may receive a plurality of sensor signals via a communication port. Furthermore, a plurality of virtual hardware environments may be prepared in one piece of hardware, and each of the pieces of virtual hardware may be handled as an individual piece of hardware.

### Definition of Terms

Data used for input is assumed to be image data, graph data, text data, or time waveform data. Output is multi-value classification for input data. The multi-value classification is one method of machine learning that outputs any of values classified into ten values from 0 to 9, for example. The data is used for supervised learning or semi-supervised learning. That is, the supervised learning necessarily has one or more classification values for each piece of input data. The semi-supervised learning has at least one or more pieces of input data for each classification value although not all the pieces of input data necessarily have classification values. In the present embodiment, a classification value for input data of the supervised learning or the semi-supervised learning is referred to as a correct answer label, and data to which the correct answer label for the input data is not correctly given is defined as a label error. A set of the input data and the output data is referred to as a dataset.

The dataset can be separated into training data and test data. Clustering or machine learning is performed on the training data, whereas training is not performed on the test data, and the test data is used in order to verify characteristics obtained by training. Furthermore, in a case where sufficient data can be prepared, for example, in a case where the number of pieces of data per correct answer label is 5,000 or more, verification data may be prepared separately from the training data and the test data. In this case, the verification data plays a role similar to that of the above test data, whereas the test data is used only once for accuracy confirmation at the time of inference by the information processing device for which training has been completed, and is not used at the time of training.

By using the verification data in this manner, it is possible to avoid over-training for the test data, and in a case where a deviation in inference accuracy (probability of inference) occurs between the verification data and the test data, it is possible to determine that over-training is performed. Therefore, in a case where the verification data is used, high inference accuracy can be obtained even in an environment close to an actual environment. Note that, in a case the number of pieces of data is small, even when the verification data is prepared, inference accuracy may fluctuate violently due to over-training or selection of input data at the time of training. Therefore, in such a case, it is desirable not to use the verification data or to consider addition of new data.

### Outline of First Embodiment

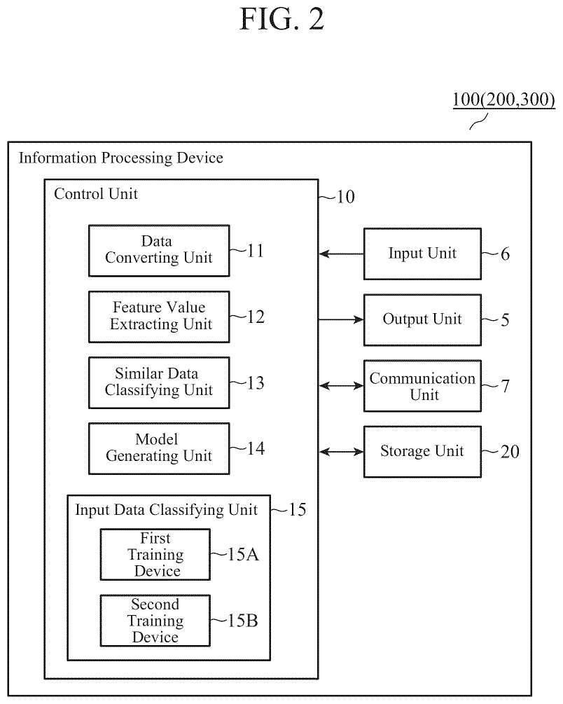

Next, an outline of the present embodiment will be described with reference to FIG. 2. FIG. 2 is a block diagram illustrating a configuration of the information processing device 100. The information processing device 100 is configured to include a control unit 10, the input unit 6, the output unit 5, the communication unit 7, and a storage unit 20 according to the above-described hardware configuration.

Input data from the input unit 6, the communication unit 7, and the storage unit 20 is input to the control unit 10. The storage unit 20 is constituted by, for example, the ROM 2a, the RAM 2b, the hard disk 2c, the drive 8, or the like, and stores various types of data and information such as type information used by the information processing device 100 and a result calculated by the information processing device 100.

The control unit 10 includes a data converting unit 11, a feature value extracting unit 12, a similar data classifying unit 13, a model generating unit 14, and an input data classifying unit 15, and performs various types of processing by the data converting unit 11, the feature value extracting unit 12, the similar data classifying unit 13, the model generating unit 14, and the input data classifying unit 15 on the basis of data input from the input unit 6 and the communication unit 7 and data and information acquired from the storage unit 20. For example, the control unit 10 outputs results of various types of processing to the outside of the unit via the output unit 5 and the communication unit 7. In addition, for example, the control unit 10 causes the storage unit 20 to store the results of various types of processing. Note that the input unit 6, the communication unit 7, and the storage unit 20 constitute an input unit in the first embodiment. The output unit 5, the communication unit 7, and the storage unit 20 constitute an output unit in the first embodiment.

The data converting unit 11 converts (deforms) input data input to the information processing device 100 by performing predetermined processing on the input data, and generates new input data. Note that the data converting unit 11 constitutes a data generating unit in the first embodiment. The feature value extracting unit 12 extracts feature values of input data from the input unit 6, the communication unit 7, and the storage unit 20, and classifies the input data. In other words, the feature value extracting unit 12 quantifies features of the input data from the input unit 6, the communication unit 7, and the storage unit 20.

The similar data classifying unit 13 performs clustering processing on the input data input to the information processing device 100. In addition, the similar data classifying unit 13 extracts feature values of the input data, determines whether the results are similar to each other by self-supervised learning, and generates a trained model. The model generating unit 14 performs training on the basis of input data from the input unit 6, the communication unit 7, and the storage unit 20, data generated by the data converting unit 11, data on which clustering processing has been performed by the similar data classifying unit 13, and the like, and generates a trained model. In addition, the model generating unit 14 performs supervised learning on a dataset having a correct answer label among those classified by self-supervised learning. In addition, the model generating unit 14 performs supervised learning on a dataset having no correct answer label using data newly given in a classification result in self-supervised learning as a correct answer label. Furthermore, supervised learning is performed on a dataset having a correct answer label among those classified by self-supervised learning by removing pieces of data having correct answer labels that do not coincide in each classification from each classification, and using only pieces of data having correct answer labels that coincide. For example, in a case where the first dataset and the second dataset include a plurality of correct answer labels associated with respective pieces of input data, the similar data classifying unit may generate a seventh dataset by excluding, from the second dataset, input data associated with a correct answer label other than a correct answer label having the largest number of pieces of associated input data among the plurality of correct answer labels included in the second dataset, and the input data classifying unit may generate a learning model by performing supervised learning using the seventh dataset.

The input data classifying unit classifies the input data by inference based on the trained model generated by the model generating unit. For example, the input data classifying unit 15 includes a first training device 15A that infers and classifies input data on the basis of the first trained model generated by the model generating unit, and a second training device 15B that infers and classifies the input data on the basis of the second trained model generated by the model generating unit. Note that the input data classifying unit may include another training device that performs inference on the input data on the basis of a trained model other than those described above. Details of each component of the control unit 10 will be described later.

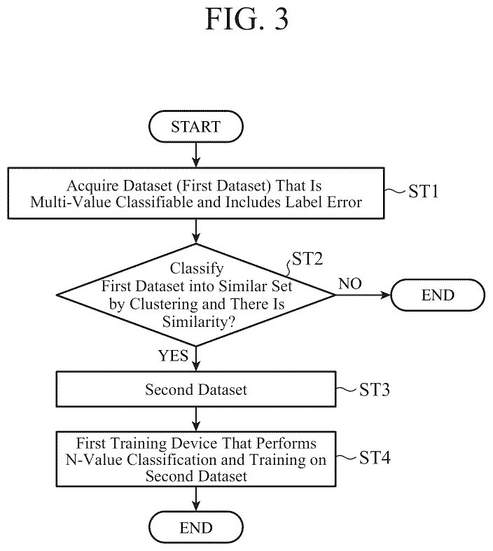

FIG. 3 is a flowchart illustrating clustering processing performed by the information processing device 100. When a dataset that is multi-value classifiable by using clustering and includes a label error is defined as a first dataset, the information processing device 100 separates the first dataset into a similar set and a dissimilar set by clustering. For example, the first dataset includes equal to more than 5% and less than 10% label errors. For example, the information processing device 100 first acquires the first dataset that is multi-value classifiable and includes input data with a label error (step ST1). After performing the processing of step ST1, the information processing device 100 determines whether or not the first dataset has been classified into a second dataset that is a similar set of pieces of input data having similar feature values by clustering processing by the similar data classifying unit 13 (step ST2).

The similar set obtained by classifying the first dataset by clustering is defined as the second dataset (YES in step ST2 and step ST3), and a first trained model that is a trained model for classifying input data by the model generating unit 14 is generated using the second dataset (step ST4). With this processing, the first training device 15A can infer input data on the basis of the first trained model.

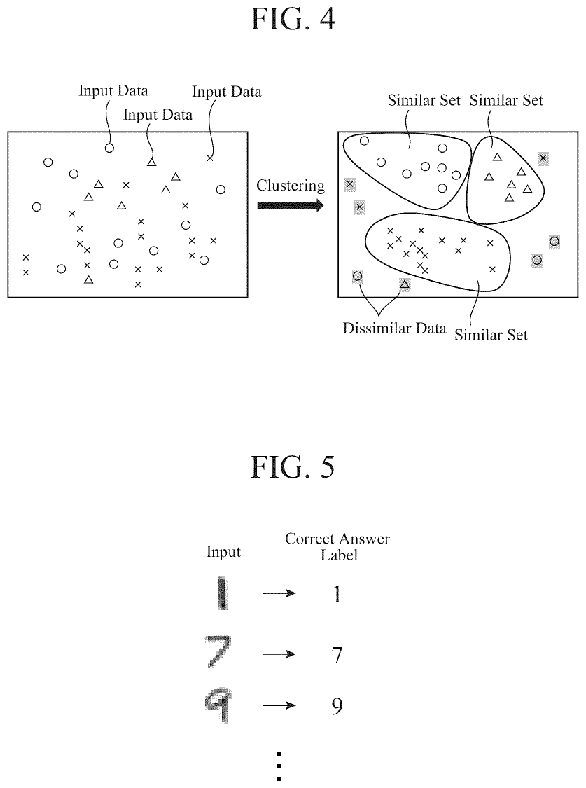

As illustrated in the schematic diagram of FIG. 4, clustering performs processing of decreasing a distance between pieces of similar data in a plurality of pieces of data, and increasing a distance between pieces of dissimilar data in the plurality of pieces of data without using a correct answer label given to input data. In the present embodiment, clustering is processing that requires training based on machine learning.

Since clustering is a method for creating a set of pieces of input data and performing training, various methods are known as a method for selecting the set of pieces of input data, a configuration of machine learning used for training, a definition of a distance between pieces of input data, and a definition of a loss function that minimizes the distance, but any method may be used. In the present embodiment, in particular, a method for performing processing using a method called self-supervised learning among methods called contrastive learning for clustering will be described. Note that the self-supervised learning is named as supervised, but minimizes a distance, that is, performs training without using a correct answer label.

Training data is separated into a similar set and a dissimilar set by clustering, data separated into the similar set is defined as the second dataset, and data separated into the dissimilar set is discarded. The second dataset is created by this method, and a first training device that classifies the second dataset into N values, in which N is the same classification number as that of the first dataset, is created. Note that the value of N is a specific integer of 2 or more, and constitutes a first number and a third number in the first embodiment.

Performance of the first training device can be confirmed by the above test data, and processing can be performed by comparing an inference value output when the test data is input to the trained first training device with a correct answer label given to the test data, and counting a case where the inference value coincides with the correct answer label as a correct answer and counting a case where the inference value does not coincide with the correct answer label as an incorrect answer. For example, when there are 10,000 pieces of test data and 9,000 pieces of test data coincide with a correct answer label, 90.00% (=(9,000/10,000)×100) can be calculated.

Verification can be performed by performing comparison using the test data. As a result, it can be indicated that a training device that has learned the second dataset as an N-value classification problem can provide more correct answers for the test data than a training device that has learned the first dataset as the N-value classification problem. Note that the test data and the verification data described above are data not used for generation of a trained model, and may be prepared as data (specific input data) different from the first dataset, or a part of the first dataset may be set in advance as the test data and the verification data before generation of the trained model.

### <First Dataset>

### Correct Answer Label

In a case of 10-value classification, integers from 0 to 9 are generally used as the correct answer labels, but the correct answer labels are not necessarily required to be continuous or start from 0. In addition, like One Hot Vector, in a case where 1 is put only at the position of a corresponding correct answer label, such as (1,0,0) for the above 1, (0,1,0) for the above 2, or (0,0,1) for the above 3, and 10-value classification is performed, a matrix of 10×10 may be output. In addition, description will be given using the 10-value classification for ease of understanding. However, in the present embodiment, a 2 or more-value classification is sufficient. For example, ImageNet, which is a well-known dataset in image recognition, has 14 million images and a classification number for 20,000 or more correct answer labels appearing in each image. However, it can also be utilized for such a large-scale dataset. In addition, although a regression problem is different from a classification problem, in a case where a correct answer of input data and a range of output are, for example, real numbers from 0 to 100, the regression problem can be converted into the classification problem that performs classification into two or more values by conversion into 100 discrete values such as 0 to 1, 1 to 2, . . . , and 99 to 100, and it can be applied to the present embodiment.

### Label Error

There are several cases of label errors described in the present embodiment. A dataset of multi-value classification will be described by exemplifying CIFAR-10 used for an image classification problem. In CIFAR10, any label of 10 values of an airplane, an automobile, a bird, a cat, a deer, a dog, a frog, a horse, a ship, and a truck is given to each piece of input data. In a case of supervised learning, correct answer labels are given to all pieces of input data, and in a case of semi-supervised learning, correct answer labels are given to only some pieces of input data. A label that does not coincide with the input data is a label error. For example, a case where a label is a cat although a dog photograph appears corresponds to the above example.

In addition, a case where a piece of input data corresponding to a label outside the multi-value classification range is included is also defined as a label error. For example, a case where an image of an apple that does not correspond to any of labels of CIFAR-10 appears with respect to image data labeled with an airplane in CIFAR-10 corresponds to the above example.

In addition, there is a case where a plurality of labels is included in input data, and in this case, there may be a case where it is determined as a label error and a case where it is not determined as a label error depending on a purpose of use. For example, a case where a cat and a dog are simultaneously included in input data labeled with a cat in CIFAR-10 corresponds to the above example, and a case where input data has both labels of a cat and a dog, and processing is performed in such a manner that it is sufficient that the input data corresponds to either of the dog and the cat is not a label error. Meanwhile, a case where processing is performed in such a manner that it is determining that it is an error unless both labels of a cat and a dog are output is determined as a label error.

In addition, a case where a label other than the multi-value classification is included is also defined as a label error. For example, in CIFAR-10, when there is an apple label not included in the correct answer label, it is determined as a label error. When an apple is included in CIFAR-10, 11-value classification is obtained, and input information labeled with an apple only needs to be removed. Therefore, in this case, a label error can be removed in preprocessing before clustering is performed.

### Input Data

Next, data to be input to the information processing device will be specifically described. In a case of the image illustrated in FIG. 5, there are a still image and a moving image. However, a multi-value classification problem of a moving image can be considered as a continuous set of still images. Therefore, only a still image will be described in the present embodiment. In the still image, there are a color image and a monochrome image. In the present embodiment, as for an input to the information processing device, there is no difference in input data other than a fact that the color image is formed by a set of two or more channels such as RGB, whereas the monochrome image is formed by one channel. Note that, although there is a plurality of types of processing in a case where there is a plurality of channels depending on a difference in algorithm of the information processing device, in general, the channels are combined into one channel by a weight matrix by full connection for combining the channels. Note that a method therefor may be any method in the present embodiment.

In addition, when the size of the image is as small as 32 pixels×32 pixels as in MNIST or CIFAR10, calculation time is short, but there is no limitation on the size as in 96 pixels×96 pixels as in STL 10, and the size is not necessarily required to be a square as described above. The image does not need to be by a CCD or CMOS camera, and an infrared sensor that converts physical data into numerical data, a radar signal, a wireless signal, a sensor signal that acquires heat, sound, vibration, electric field, magnetic field, or the like, a graphic displayed or created on a computer, CAD, or the like may be utilized.

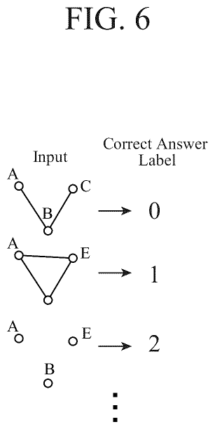

A plurality of problem settings can be considered for the classification problem in the graph illustrated in FIG. 6. The graph includes a node that is a point and an edge that is a line connecting the points, and any information can be embedded in the node and the edge. As a main classification problem in such a graph, there are a first problem of classifying nodes from an edge and graph information, a second problem of classifying edges from a node and graph information, and a third problem of classifying graphs by training a plurality of graphs. Furthermore, use depending on a purpose can be performed, for example, prediction is performed as a classification problem for selecting a feature of a node from finite choices, or prediction is performed as a classification problem for selecting a feature of an edge from finite choices.

As an example, since an electric circuit is known to be a graph, description will be given on the basis of the electric circuit. In the electric circuit, when an input is a circuit diagram and an output is an output voltage between any terminals of the circuit, one of problems of classifying nodes is to select circuit components in such a manner as to obtain a desired output voltage. There are only finite types of circuit components such as a capacitor, a coil, a diode, and a resistor, which causes a classification problem. Next, in a problem of classifying edges, all necessary components are included in a graph as a circuit diagram, and a problem of predicting a wire connecting the components is a classification problem. Strictly speaking, two or more nodes are required, but when there are two or more components, this is a multi-value classification problem, and thus is within the scope of the present embodiment. Next, a problem of classifying graphs can be used, for example, for a problem of classifying a graph obtained as one circuit diagram into any one of a step-up power supply, a step-down power supply, and a step-up/step-down power supply, or for a problem of classifying the graph into any one of a power supply circuit, a sensor circuit, a communication circuit, and a control circuit.

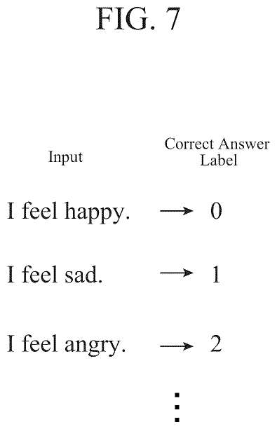

In the classification problem in the natural language processing illustrated in FIG. 7, as an input signal, what is obtained by cutting out a part of a block of text, such as one sentence, one paragraph, one clause, or the whole sentences, is given. For example, when a certain news article is given, it is a classification problem to infer into which of economy, politics, sports, and science the news article is classified, and the method of the present embodiment can be used for such a problem. This is a classification problem evaluated in one sentence or one paragraph. However, for example, a problem of inferring an author and a genre of a book for one given novel is also a classification problem, and thus the method of the present embodiment can be used. Furthermore, emotion analysis in which pieces of input data are classified into delight, anger, sorrow, and pleasure is also a classification problem, and the method of the present embodiment can be used for such a problem.

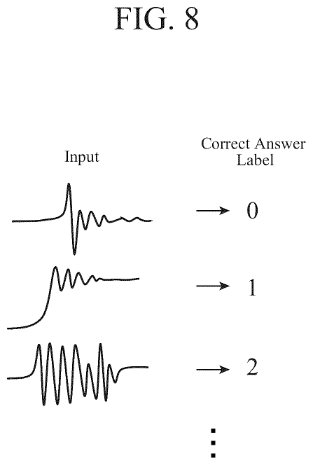

The classification problem in the time waveform illustrated in FIG. 8 classifies the time waveform when the time waveform in which the horizontal axis is time and the vertical axis is any physical information such as a voltage or a peak value is input data. For example, in the example of the above circuit, the method of the present embodiment can also be used for a problem of classifying a power supply circuit, a sensor circuit, a communication circuit, and a control circuit from a time waveform of a circuit diagram using the time waveform as an input. In addition, the horizontal axis has been described as time, but any feature value such as frequency or coordinates may be used as long as the feature value has a physical spread. In addition, the time waveform is not necessarily required, and for example, the time waveform may be Fourier transformed, and the horizontal axis may be a frequency and the vertical axis may be an amplitude.

Although the main data has been described above, any input data may be used as long as it is data that can be input to AI, such as a numerical dataset having a plurality of parameters and can be represented in a table format, such as iris Dataset (classified into three types from four types of numerical feature values), and can be converted into a form in which an output is obtained by classification.

### Number of Pieces of Input Data

Although the number of pieces of data varies depending on a dataset, in a case of supervised learning, it is desirable to prepare input data such as 1,000 or more images, graphs, time waveforms, and character strings for each correct answer label. In addition, a state in which dispersion of similar data is small in one correct answer label is not desirable, and a training dataset having dispersion that can include a result expected at the time of inference is desirable. As one means for confirming whether training data and inference data have similar dispersions, in a case where the same inference accuracy is obtained even when the whole or a part of the training data and the inference data is interchanged, it can be considered that the dispersions are similar.

In addition, a method called data augmentation may be used in order to increase input data. Note that, in a case of an image, it is possible to use data augmentation that increases training data by affine transformation or the like. However, for example, augmentation of a single time waveform is difficult, and it is not possible to use augmentation for any data.

In a case where the amount of data to be used for training is small, training may be performed using a similar dataset (for example, the above-described ImageNet) in which a large amount of data can be obtained or a huge amount of data acquired by a similar sensor, or training may be performed by performing transfer learning or fine tuning using a small amount of acquired data with a variable or a weight matrix as an initial value. Note that transfer learning is a training method performed by slightly changing an element of a variable or a weight matrix serving as an initial value, and fine tuning is a method for training only full connection by fixing a variable or a weight matrix. Note that transfer learning and fine tuning are often used in combination. Transfer training and fine tuning may be combined, for example, first, full connection is optimized using fine tuning several times, and then a feature value included in a weight matrix is optimized by transfer learning.

Also in a case of semi-supervised learning, there is a disadvantage that bias is generated in training and inference accuracy decreases due to a small amount of labeled data although it is the same as supervised learning. Therefore, training can also be performed, for example, by a method in which training is performed by unsupervised learning such as self-supervised learning, and a correct answer is given after training. Also in this case, there are desirably 1,000 or more pieces of training data having no correct answer label for each correct answer label.

### <Information Processing Device>

### Clustering

Clustering refers to a method for dividing pieces of data into groups depending on similarity of pieces of input data. In many cases of clustering, into how many groups pieces of data is divided is a hyperparameter determined by a designer or a user of machine learning. In the present embodiment, since the number of correct answer labels is determined, it is desirable to classify pieces of data by clustering into the same number as the number of correct answer labels, for example, 10 in a case of CIFAR-10. K-means is the most mainstream in the classical clustering algorithm, but after the advent of deep learning, deep learning-based clustering, clustering based on a decision tree, such as a gradient boosting method, and the like are known, and any method may be used in the present embodiment. In the present embodiment, deep learning-based clustering that can easily provide inference accuracy for many pieces of data will be described.

As an evaluation index of clustering, a plurality of methods such as an adjustment rand index (ARI) and a normalized mutual information amount (NMI) are known, and clustering that has performed training may be evaluated using these methods. Note that, in the present embodiment, since a correct answer label is given although a label error is included, evaluation may be performed by, for example, determining labels of a similar set obtained by clustering by majority decision of the correct answer labels given to the labels using similarity of the same correct answer labels as an index. For example, in a case where 1,000 elements are included in a certain similar set, and 900 labels are constituted by 1, 70 labels are constituted by 7, and 30 labels are constituted by 9 among the 1,000 elements, 900 labels of 1 may be given to the 1,000 elements by majority decision. Note that it is necessary to perform processing in such a manner that different similar sets do not have the same label.

### Unsupervised Learning

The above clustering corresponds to unsupervised learning. Machine learning is generally classified into supervised learning that gives a correct answer label, unsupervised learning that does not give a correct answer label at all, and reinforcement learning that maximizes a reward set as a purpose although there is no correct answer. Semi-supervised learning is intermediate between supervised learning and unsupervised learning, but may be defined as a method of supervised learning because a correct answer label is partially used.

In the present embodiment, since a correct answer label is given to the first dataset, supervised learning and semi-supervised learning can be performed on the first dataset. However, it is characterized in that the second dataset is created by performing training by clustering which is unsupervised learning instead of using the supervised learning, and distilling training data (removing unnecessary data). As a result, even in a dataset including a large number of label errors as in the present embodiment, the second dataset can be created without affecting an error ratio of a label and the quality of data.

### Self-Supervised Learning

In the present embodiment, a method called self-supervised learning in deep learning-based unsupervised learning is used. Self-supervised learning has been studied as one of Siamese network methods which are basic methods in meta-learning.

Meta-learning is a method for training a training method, and is mainly divided into metric-based training, model-based training, and optimization-based training, and the Siamese network is considered as one type of metric-based training. The metric-based training is a method in which, when a set of two or more pieces of data is considered, a distance between pieces of data close to each other is decreased, and a distance between pieces of data far away from each other is increased. Various methods are known for definition of a distance. Examples thereof include a method based on a statistical distance such as a Mahalanobis distance, and a method in which a distance is defined on the basis of a mutual entropy, a mutual information amount, a cross entropy, a Kalback Liebler information amount, or a cross correlation matrix. Similarity between feature values is measured by combining one or more of these statistical amounts and information amounts. In addition, a vector amount that is a result of feature value extraction may be simply obtained, and similarity between two pieces of input data may be measured by cosine similarity from two vectors for the two pieces of input data. In addition, expression as a distance matrix obtained by collecting results of calculating a similarity between pieces of input data in a matrix form is also a desirable use method.

In self-supervised learning, similar input data is created by calculation such as extracting or removing a part of original input data, and a distance between pieces of data created from one piece of input data is decreased. Meanwhile, data created from data with another label is processed in a similar manner, and processing is performed in such a manner that a distance between pieces of data close to each other is decreased, and a distance between pieces of data that can be determined to be far away from each other is increased. Furthermore, since feature values of the input data can be extracted by a method such as full connection, convolution, or Attention, which is processing of deep learning, similarity between pieces of data can be calculated by measuring a distance between the feature values.

As clustering in the present embodiment, it is necessary to use clustering with high accuracy for classification into similar data and dissimilar data. This is because, when clustering with low classification accuracy is used, a large amount of data is classified into dissimilar data, and as a result of reduction in training data or dispersion of training data, inference accuracy for test data may decrease. Clustering performance can be determined by checking input data classified into dissimilar data and determining whether a large amount of data other than data considered to be an abnormal value is included. In a case where a large amount of such data is included, it is desirable to use a different clustering method. In particular, clustering based on deep learning often has high classification accuracy, and can provide high classification accuracy for many pieces of data including label errors.

Information Processing Device that Processes Input Data

An information processing device for extracting a feature value necessary for self-supervised learning will be described. The first training device is the same as a general supervised learning device for solving a general classification problem, and therefore will not be described. In addition, a difference between the first training device and the self-supervised learning device is that an evaluation function defining an evaluation index is different, and a softmax function necessary for class classification is not used. Full connection immediately before an output layer of the first training device is not necessarily required, and aggregation into a desired classification number may be performed by calculation of feature value extraction before input to the full connection. Note that, in many cases, the inference accuracy tends to be improved by applying the softmax function. In addition to the softmax function, a nonlinear function obtained by deforming the softmax function, such as a log-softmax function, may be used.

Next, an example of a method for extracting a feature value for various pieces of input data will be described. In a case of an image, as described above, a convolutional neural network (CNN), a multi-layer perceptron (MLP), or Attention (selective attention)-based Transformer is often used. Note that it is also possible to process an image by a graph neural network (GNN) used in a graph theory described below, a relational neural network (RNN) used for time-series processing, or a technique applying these. In addition, although deep learning is used in the above description, logistics regression, a support vector machine, a gradient boosting method, or the like may be used, and any algorithm may be used in the present embodiment.

In particular, various algorithms are known in deep learning, and a large number of algorithms such as VGG, ResNet, AlexNet, MobileNet, and EfficientNet are known while these have a common point that convolution is performed also in CNN. In addition to these, also in MLP, a method that can obtain high inference accuracy only by processing an image with simple full connection, such as an MLP-Mixer, is known, and these methods may be used. In addition, Vision Transformer that processes an image by Transformer, a method obtained by combining a Transformer and feature value extraction of a CNN, and the like are known, and processing can be performed by these single methods or a combination thereof.

For a graph, a graph neural network (GNN), a graph convolutional network (GCN) that convolves a nearby node, or the like is used. Since the graphs are not arranged at equal intervals unlike images, the graphs cannot be input to deep learning as they are. Therefore, the graph is converted into an adjacent matrix or an order matrix having a one-to-one correspondence with the graph, and input. Here, the adjacent matrix is a method for expressing presence or absence of connection between nodes by a matrix, and is an N×N matrix in a case where there are N nodes. In a case of an undirected graph having no edge orientation, the adjacent matrix is a symmetric matrix. The order matrix is a method for expressing the number of edges included in each node by a matrix, and is an N×N matrix and is a diagonal matrix in a case where there are N nodes. By inputting such a matrix obtained by conversion to a GNN or a GCN and inputting the matrix to full connection, a softmax function, or the like immediately before an output layer through a plurality of hidden layers such as the GNN, the graph can be handled as a classification problem.

In a case of a time waveform, an RNN is often used, and a gated recurrent unit (GRU) obtained by extending the RNN and a long short-term memory (LSTM) are main techniques. In addition to these, a combination of Transformer and a technique using an Attention mechanism that is an original of Transformer, a temporal convolutional network (TCN) using discrete convolution, and the like are known. By using these techniques for input data, data can be input to deep learning.

In a case of natural language processing, the LSTM that handles a time waveform and a technique called a sequence to sequence (Seq2Seq) that is an evolved system of the LSTM are known. Furthermore, an Attention mechanism that is an evolved system of the sequence to sequence (Seq2Seq) and a Transformer technique that is a further evolved system of the Attention mechanism are known, and natural language processing can be performed using these techniques. Note that the LSTM can predict a language from a context of text, but has a problem that only a signal having a fixed length can be handled, and therefore accuracy varies depending on the length of text. The Seq2Seq has solved the problem by incorporating a concept of Encoder-Decoder.

Note that Attention is a method in which a correlation is introduced between words constituting text due to insufficient accuracy and accuracy is improved, but Attention cannot perform parallelization, and cannot handle a large-scale dataset. Therefore, since Transformer is a method in which parallelizing in Attention is possible using dedicated hardware such as a GPU, there is a difference in inference accuracy and calculation time, but original techniques are common. Therefore, any method may be used in the present embodiment.

In self-supervised learning, a feature value is extracted by the above method. At this time, it is necessary to create comparison data. In the information processing device 100, in a case where input data is an image, the data converting unit 11 can create a plurality of images from one input image by extracting a part of the input data, removing a part of the input data, performing affine transformation such as rotation or stretching, superimposing white noise or the like, or changing color balance or sharpness in a case of a color image such as RGB. In particular, since it is found that a distance between extracted feature values of images created from the same input image is short, training can be performed by performing processing of decreasing the distance.

Meanwhile, in a case of a graph, a natural language, or time-series data other than an image, there are often many physical constraints. For example, in a case of a graph network that processes a circuit diagram, it is possible to extract or remove some edges or some nodes similarly to an image. However, at the time of extraction or removal, only deformation to data following a physical law such as Kirchhoffs law is possible. In a case of handling a circuit as an example, a path through which a current flows needs to be a closed loop. Therefore, extracting an edge optionally in order to create a new graph network and making the closed loop an open loop does not satisfy physical constraints. Therefore, it is necessary to create data in consideration of the physical constraints.

The same applies to natural language processing, and it is possible to extract or remove a part of text, but it is difficult to replace a word with a synonym because a context needs to be understood, and it is also difficult to randomly change order of sentences. However, in a case of text, since data is easily obtained as compared with other data, a method for searching for similar text from many pieces of data can be often used. Also in time-series processing, it is possible to extract or remove a part of a waveform, but it should be noted that data for which a physical law such as continuity of a waveform holds cannot be processed by a method that does not follow a physical law even at the time of extraction or removal. Also in a case of deforming a waveform or the like, random deformation is not desirable, and it is desirable to perform deformation under a condition following a specific theoretical equation such as Fourier series expansion.

### <Creation of Second Dataset>

A feature value of data having a label error is extracted by self-supervised learning, and a result thereof is defined as a second dataset constituted by a similar set corresponding to the number of clusters. As illustrated in FIG. 3, data having no similarity is removed and is not included in the second dataset. In the second dataset, a result in the following <Experimental results> was obtained under a condition of using the same label as the label given to the first dataset, but the label of the data determined to be the similar set in the result of the self-supervised learning may be changed, and the data may be used as the second dataset.

### <Training and Inference of First Training Device>

Training and inference of the first training device are similar to training and inference of general deep learning. Specifically, a weight matrix such as convolution or Attention is calculated for input data, the same number as the number of correct answer labels is defined as a classification number by a method such as full connection that is a class classifier for aggregating feature values, and a difference between a result of performing a softmax function or the like and the correct answer label is calculated at the time of training. The difference is propagated from an output side to an input side by an error back propagation method, and a weight matrix is updated.

Meanwhile, in inference, a weight matrix and a weight of full connection obtained by training are calculated for test data, and an output thereof is output as an inference value. A non-linear function used immediately before an output layer at the time of training, such as a softmax function, is used in order to convert a small difference in feature value to be large, to perform the conversion in such a manner that a difference between a correct answer label and an output of machine learning clearly appears, and to easily update a weight matrix by error back propagation, and therefore does not necessarily need to be used at the time of inference.

It is desirable to perform inference used in the first trained model for test data. In addition, it is also desirable to perform inference with the first trained model after the feature value extracting unit classifies test data with similarity. At this time, the feature value extracting unit calculates similarity with a plurality of pieces of data in the second dataset used for the first trained model, and extracts only a piece of input data determined to be similar. In addition, in a case where there is a plurality of pieces of test data, similarly to when the first trained model is created, the feature value of each piece of test data may be calculated, similarity may be obtained using a result of the calculation, and inference may be performed with the first trained model only for a piece of data determined to be similar.

### <Experimental Results>

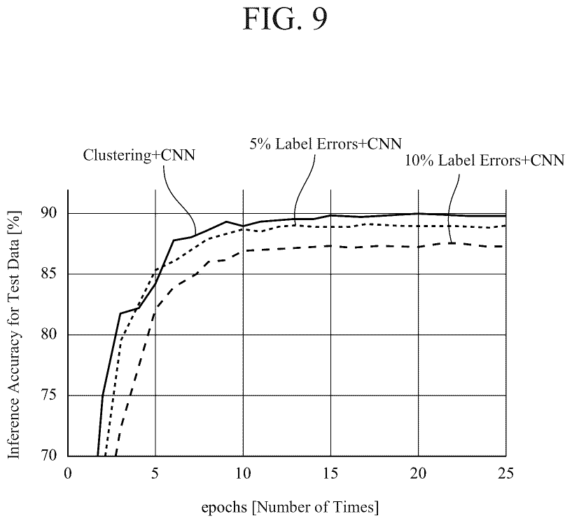

Effects of the present embodiment will be described with reference to experimental results in FIG. 9. FIG. 9 is an experimental result using data of CIFAR-10 as a dataset. As the data of CIFAR-10, data in which label errors were randomly given to 5% and 10% of labels in preprocessing was created. Note that, since training data of CIFAR-10 is a total of 50,000 pieces of data including 5,000 pieces of data for each label, in a case of 5% label errors, a total of 2,500 labels have errors, in which each label has 250 errors.

As a model of self-supervised learning, a method called swapping assignments between views (SwAV) (article name: Unsupervised Learning of Visual Features by Contrasting Cluster Assignments) to which a method called SimCLR (article name: A simple framework for contrastive learning of visual representations) is applied was used. Note that the classification number which is a hyperparameter is 10, which is the same as the number of correct answer labels of CIFAR-10.

When clustering was performed by this method, 1,336 pieces of data in the first dataset were dissimilar data. Therefore, the remaining 48,664 (=50,000-1,336) pieces of data were defined as the second dataset. Then, when training was performed on this second dataset using VGG13 (abbreviation of visual geometry group 13, article name: Very Deep Convolutional Networks for Large-Scale Image Recognition), which is one type of CNN, the result illustrated in “Clustering+CNN” in FIG. 9 was obtained.

From the result of FIG. 9, it is found that inference can be performed with accuracy of 90.00% at 20 epochs (the number of times of updating a weight matrix). Meanwhile, in the data having 5% label errors, when clustering is not performed and training is performed with the same VGG13 as described above, at 20 epochs, accuracy was 89.03%, which indicates a decrease in accuracy by about 1% as compared with that in clustering+CNN. Furthermore, when similar training is performed for data having 10% label errors, accuracy was 87.30%, which indicates a decrease in inference accuracy by about 2.7% as compared with that in “clustering+CNN”. This time, the number of epochs is up to 20, but the above relationship is not changed even when the number of epochs is up to about 200, and the inference result of “clustering+CNN” is the best as in FIG. 9.

It is found from this result that although it is generally said that it is better to increase the amount of data in machine learning, in a case where there are some errors in labels, it is better to perform training after removing erroneous data by clustering. In particular, in an actual environment, for example, in a case of an image constituted by sensor data, when data other than target data is included at the time of data acquisition, a label error is likely to be generated. In addition, in a situation where a correct answer label is manually given in classification of waveforms and classification of circuits, a label error is likely to be generated due to human skills, and it is difficult to calculate a label error ratio thereof manually. In particular, the present embodiment is based on a finding that, by removing data including a label error, the inference accuracy can be improved although the number of pieces of data is reduced.

Furthermore, an effect obtained by removing (distilling) data by clustering will be described. First, over-training can be prevented. In general, it is possible to perform training including a label error by using large-scale machine learning having many learnable parameters. Note that this is a result of fitting too much to training data or test data. Therefore, high inference accuracy can be obtained in a closed dataset such as a general dataset used for machine learning examination, but the inference accuracy decreases in a case of data acquired in an actual environment such as a factory. On the other hand, when the method of the present embodiment is used, this over-training can be reduced.

Second, a person can confirm removed data. In general, processing of machine learning is called a black box, and there is no method for clearly indicating processing of machine learning itself and a basis of an output to a person. Meanwhile, a person checks a classification result of input data, which is intermediate processing, and analogizes a tendency of an error, whereby it is easy to estimate a determination reason of the machine learning. For example, by grasping a tendency that data in which a subject appears at a center of an image is likely to be classified into a similar set and data in which a subject appears at a corner of an image is likely to be classified into a dissimilar set, it is possible to use the tendency for optimization of a machine learning model.

Third, once the second dataset is created by clustering, it is not necessary to perform calculation many times. Clustering using self-supervised learning tends to require more calculation time and calculation amount than general supervised learning. However, the calculation is performed in order to obtain the second dataset, and it is not necessary to perform recalculation at the time of training or inference by a second training device. In particular, in design of machine learning, the most time is required to select a model of supervised learning or to create a learning model for reducing an influence of a label error on an inference result. Therefore, since time required for the clustering is relatively short and manual labor is not required, an effect of shortening a development period of machine learning can be expected.

Fourth, use for a small dataset is also possible. As described above, in clustering based on self-supervised learning, since training data can be created from self data and training can be performed, clustering can be performed even when the number of pieces of training data is as small as 1,000 or less. Note that the number of pieces of data of the second dataset is also reduced, it is desirable to perform fine tuning using a trained model pre-trained with similar data. Note that, in a case where there are the number of pieces of data, a time required for calculation, and calculation resources, it is also a good method to use a combination of transfer learning and fine tuning.

### Second Embodiment

### <Overview>

In the first embodiment, data determined to be dissimilar in clustering is discarded, whereas in an information processing device 200 according to the present embodiment, outliers that are data determined to be dissimilar are collected and defined as a third dataset, and a method for performing training using the third dataset will be described.

### <Outlier>

The outlier in the present embodiment is defined as an outlier obtained by clustering a first dataset as illustrated in FIG. 3, extracting N similar sets, and combining the remaining pieces of dissimilar data into one. For example, 1,336 pieces of input data discarded when SwAV is applied to CIFAR-10 described in the experiment of the first embodiment correspond to the outlier in the present embodiment. Data obtained by collecting the outliers is defined as the third dataset.

### <New Label>

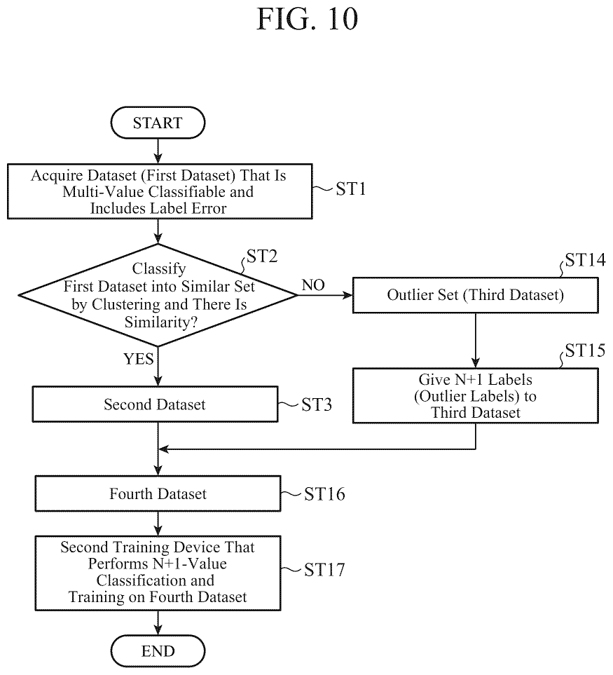

As illustrated in FIG. 10, for example, the information processing device 200 defines dissimilar data that has not been classified into a similar set by clustering of the first dataset as the third dataset that is an outlier set (NO in step ST2 and step ST14), gives an outlier label (first label) to the third dataset (step ST15), and creates a fourth dataset in combination with the second dataset (step ST16). In a case where the second dataset is an N-value classification, the fourth dataset can be a dataset with an N+1-value label by setting the outlier label to N+1.

### <Training by Second Training Device Using Fourth Dataset>

Training by the second training device is performed using the fourth dataset (step ST17). Apart of the outlier label data in the fourth dataset is defined as test data. When the number of pieces of the outlier label data is larger than the number of pieces of data of each label of the second dataset, it is desirable to select the same number of pieces of the outlier label data as the number of pieces of the test data of the second dataset. When the number of pieces of the outlier label data is smaller than the number of pieces of data of each label of the second dataset, it is desirable to output the outlier label data at the same ratio as that of the second dataset. For example, in a case of CIFAR-10, since there are 5,000 pieces of training data for each label and there are 1,000 pieces of test data for each label, 20% is defined as the test data.

On the other hand, since the number of outliers by clustering described in the experiment of the first embodiment is 1,336, it is only required to define 270 outliers, which are 20% of the 1,336 outliers, as test data, and to define the remaining 1,066 outliers as training data. Note that, in a case where the number of pieces of the training data of the third dataset is approximately 1,000 or less, over-training is likely to occur, and therefore it is desirable to perform processing with the first training device described in the first embodiment. Although the number of the above 1,066 pieces of training data is not sufficient, experimental results will be described at an end of the present embodiment in order to indicate effects.

The fourth dataset is created by combining the third dataset created as described above with the second dataset, and a second trained model is generated by performing training by the second training device using a machine learning algorithm in the same manner as the first training device. A difference from the first training device is that training is performed by N+1-value classification and inference accuracy is confirmed by test data, but this processing is similar to that of the first embodiment and description thereof will not be repeated in the present embodiment.

### <Third Training Device Using Third Dataset>

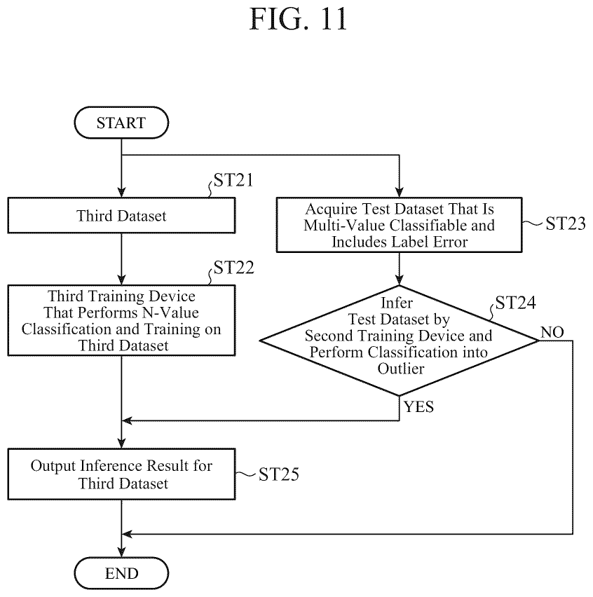

In a case where the number of pieces of data determined to be outliers is sufficiently large, a third training device (not illustrated) can be created. FIG. 11 is a flowchart illustrating processing related to the third training device of the information processing device 200. Similarly to the first training device, the third training device performs training as N-value classification using the third dataset (step ST21 and step ST22). As a result, the model generating unit 14 generates a third trained model. The information processing device 200 acquires a test dataset that is multi-value classifiable and includes a label error (step ST23), infers the test dataset by the second training device, and determines whether or not the test dataset is classified into an outlier (step ST24). The information processing device 200 outputs an inference result for the third dataset on the basis of the results of steps ST22 and ST24 (step ST25). A method for creating the training data and the test data is the same as that of <Training by second training device using fourth dataset> described above, and thus will not be repeated. Note that, in order to create the third training device, there are desirably 1,000 or more pieces of data for each label in a case of 10-value classification. Furthermore, since the third dataset includes many abnormal values that are difficult to obtain, it is desirable to use data augmentation in a case where the data augmentation can be used, for example, in a case where the data is an image, although it depends on the type of data.

<Processing when Data is Inferred to be Outlier>

Four processing methods in a case where input data (input data not used for generating a learning model) not included in the first dataset is determined to be an outlier label as a result of inference by the second training device will be described. A first method is a method for inferring data determined to be an outlier label (first input data) using a training device trained with the first dataset, a second method is a method for inferring data determined to be an outlier label using a training device trained with the second dataset, a third method is a method for inferring data determined to be an outlier label using a training device trained with the third dataset, and a fourth method is outputting that determination is impossible in a case where data is classified into an outlier label.

In the first method, it is easy to obtain high inference accuracy in a case where there is sufficient data and few label errors. In this case, since the third data has also a sufficient number of pieces of data and has a small number of label errors, the inference accuracy of the training device itself trained using the first dataset tends to be high.

The second method can provide high inference accuracy in an actual environment with many label errors. Note that, in this case, since training is performed with data from which the second label error has been removed, in a case where input data itself determined to be an outlier label is an abnormal value, the abnormal value is likely to be determined as an incorrect answer.

The third method is effective in an actual environment in which there is a sufficient amount of data and there are many pieces of data classified into dissimilar data by clustering. In particular, the third method is a machine learning device that excels in an outlier, and therefore is effective in a situation where outlier determination is important. Note that, in a case of data created for machine learning, such as CIFAR-10, since the number of pieces of data is not large and the number of pieces of data classified into an outlier is small, inference accuracy is likely to decrease.

In the fourth method, in conventional information processing, even in a case where abnormal data is input, data can be prevented from being forcibly output by performing N+1-value classification. In a case where a person can make a final determination in an actual environment such as image diagnosis of medical data (X-ray or MRI), it is not necessary to make a forced determination. By not making a forced determination, an error ratio can be largely reduced.

Note that the above description is a guide, and any method may be used depending on a label error ratio in the first dataset, the type of data, required performance, and the like, and a plurality of methods may be used in combination.

### <Deformation of Input Data as Outlier>

A method will be described in which input data is inferred by the second training device, processing of deforming (converting) input data determined to be an outlier label by the data converting unit 11 is performed, and then inference is performed. As described in the first embodiment, for example, in an image, processing such as affine transformation or noise superimposition can be performed.

Specifically, in an image, for example, 1,000 or more images are generated from one image by combining cutting out and extracting a part of input data, removing a part of the image, applying affine transformation such as scaling and rotation, adding noise, changing color balance in a case of a color image such as RGB, changing sharpness, and the like for input data determined to be an outlier label.

A first method is a method using a training device trained with the first dataset, a second method is a method using a training device trained with the second dataset, and a third method is a method using a training device trained with the third dataset. A fourth method is a method using a training device trained with the fourth dataset. Four processing methods will be described, but since features in each case are similar to those of the methods described in <Processing when data is inferred to be outlier>, the same description will not be repeated, and only a difference will be described.

In the first method, P pieces of input data (second input data) newly generated by deforming test data in a superimposed manner from 1 to P (≥3) times by the data converting unit 11 are inferred by a training device trained with the first dataset, the number of times of inference result for each label is counted, and a label assigned the largest number of times (for example, when the test data is image data indicating integers from 0 to 9, P=4,000, and the number of times of inference for 0 is 100, the number of times of inference for 1 is 100, the number of times of inference for 2 is 200, the number of times of inference for 3 is 300, the number of times of inference for 4 is 400, the number of times of inference for 5 is 500, the number of times of inference for 6 is 600, the number of times of inference for 7 is 700, the number of times of inference for 8 is 700, and the number of times of inference for 9 is 900, 9 whose number of times of inference is 900, which is the maximum number, is output as a label) is defined as an inference value. In this case, in a case where a label error ratio to the entire dataset exceeds 5%, the results tend to vary, but in a case where the label error ratio to the entire dataset is less than 5% and training is performed with a sufficient amount of data, a stable result can be obtained. Note that a value of P constitutes a second number in the second embodiment.

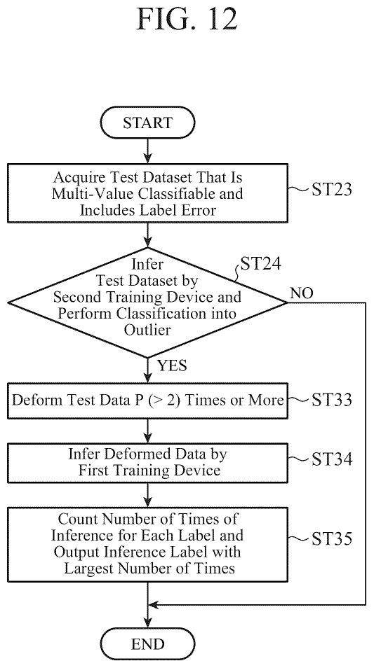

In the second method, as illustrated in FIG. 12, the first training device infers P pieces of input data (second input data) newly generated (step ST33) by deforming test data in a superimposed manner from 1 to P (≥3) times by the data converting unit 11 (step ST34), the number of times of inference result for each label is counted, and a label assigned the largest number of times is defined as an inference value as in the first method (step ST35). In the second method, in a case of an abnormal value not included in training data, correct determination is difficult even when the generated data is increased, but in many cases, the second method is effective in increasing inference accuracy.

In the third method, newly created P pieces of input data are inferred by the third training device as in the above method. Since the third training device, which is the third method, is an information processing device that excels in abnormal values, the third training device is effective in increasing inference accuracy if input data that can train the third training device can be prepared.

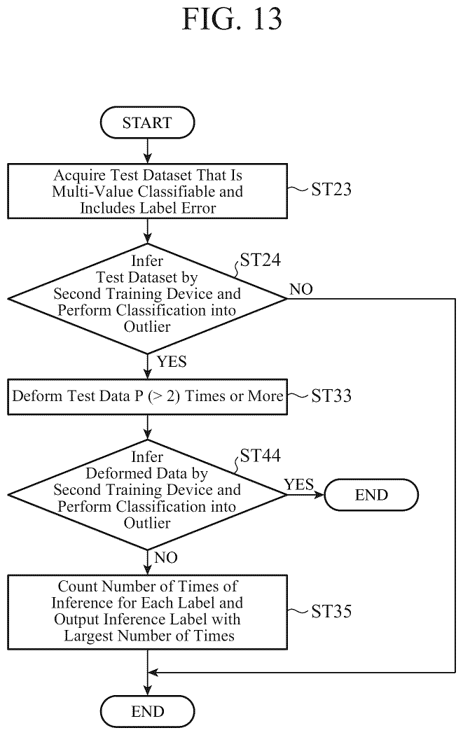

In the fourth method, as illustrated in FIG. 13, the second training device infers a plurality of pieces of input data (second input data) obtained by deforming test data P times, in which P is three or more (P>2), data classified into an outlier is discarded, the number of times of inference is counted as an inference value classified into a value other than an outlier (step ST44) as in the first method, and an inference result having the largest number of times of inference among correct answer labels other than the first label is output.

Although it has been described above that the number of times of inference is counted and calculation is performed by majority decision, as described in the fourth embodiment, a method for calculating information entropy from an average value of output results of an information processing device and outputting a label having minimum information entropy may be used. In any of the above methods, P may be 2 or more. In addition, the above-described second input data may be generated from one piece of input data by the similar data classifying unit performing predetermined processing (for example, 1 to P superimposing deformations) on first input data determined to be dissimilar or classified into the first label by inference based on the feature value extracting unit or the second trained model.

### <Experimental Results>

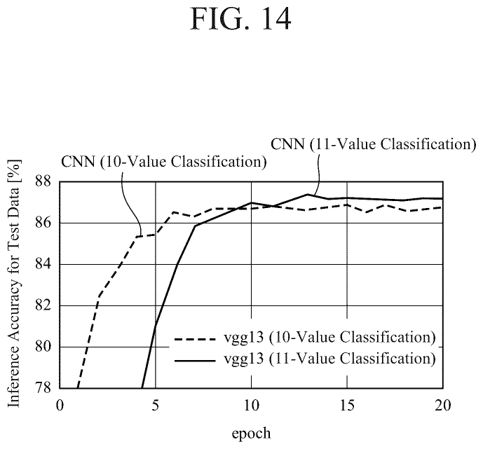

FIG. 14 illustrates a result of inferring test data by the second training device, removing input data classified into an outlier, and calculating inference accuracy of a result classified into a value other than the outlier. As illustrated in FIG. 14, when the first dataset using training data of CIFAR-10 as it is subjected to 10-value classification, accuracy was 83.78% at 20 times of epochs in CNN-based VGG13, whereas in the second training device that performs 11-value classification on the fourth dataset, accuracy was 84.20% at 20 times of epochs in the same CNN-based VGG13 as described above, which indicates improvement in accuracy by about 0.5%. Note that the number of pieces of data classified into an outlier by the second training device is 521 out of 10,000 pieces of test data. These pieces of data are discarded and are not compared with a correct answer label, and therefore do not have an influence on the inference accuracy.

In addition, in <Deformation of input data as outlier>, the fourth second training device performs inference, input data as an outlier is deformed and about 1,000 combinations are created, the second training device performs inference again, and the number of times of occurrence of data other than the outlier was counted. As a result, it had been found that the inference accuracy was 84.49%, which indicates an increase by about 0.7% similarly to FIG. 14. Note that what is different from FIG. 14 is that the inference accuracy is improved as a whole because all pieces of test data are compared with a correct answer label.

Note that the way of deformation is a hyperparameter. For example, in a case of CIFAR-10, although data is created by rotation or stretching by affine transformation, for example, the following features were observed. That is, the inference accuracy was easily improved by inclusion of data in which the angle of rotation was equal to or more than ±15 degrees and equal to or less than +45 degrees, and although there was no meaning of stretching when the vertical and horizontal stretching was equal to or less than +10%, the inference accuracy was deteriorated when the vertical and horizontal stretching exceeded ±30%. Therefore, it is necessary to search for an optimum deformation condition manually or mechanically with a large-scale computer. Note that, in a case where a computer environment can be obtained, or if a range of variation is roughly known and the deformation condition can be optimized, the inference accuracy can be improved by a simple method.

### Third Embodiment

### <Overview>

As described in the first embodiment, the number of classifications by clustering is a hyperparameter that needs to be determined by a designer of machine learning. Data to which a correct answer label is given and whose classification number is determined like the first dataset only needs to be divided into the number, but the division number of data in an actual environment cannot be clearly determined in many cases. A method performed by an information processing device 300 of the present embodiment can be used in such a case.

### <Clustering>

As described in the first embodiment, it is assumed that machine learning used for clustering uses an algorithm such as k-means or self-supervised learning. Each algorithm needs to define the number of clusters as a hyperparameter. A training device of the information processing device 300 in the third embodiment performs training in such a manner as to classify input data into the defined number of clusters, and generates a fourth trained model by the model generating unit 14.

### <Optimization of Classification Number>

As in the first and second embodiments, description will be given using data of CIFAR-10 whose classification number is known. Note that it is assumed that an actual target dataset is data whose classification number is unknown. This can be used in many situations of an actual environment, for example, in a case where the classification number of two or more measurement results obtained by physical experiments is unknown, or in a case where the classification number of types of customers who have purchased products is unknown.

The information processing device 300 sequentially calculates the number of clusters from M (fourth number, M is 2 or more)=2, which is a specific integer, gives M different labels to each similar set as described in the second embodiment, and classifies the similar set into training data and test data as an M-value classification problem. Note that the classification number N can often be assumed by an empirical rule or the like. In this case, clustering may be started from a positive integer M equal to or more than the classification number N. This is because a calculation amount is reduced, and it can be expected that inference accuracy increases as the number of clusters increases. If the number of clusters as many as the number of pieces of training data is defined, it is only required to define one similar set for each piece of training data, and therefore the inference accuracy can be 100% under any condition. Note that, when the number of clusters is too large, a purpose of clustering is lost.

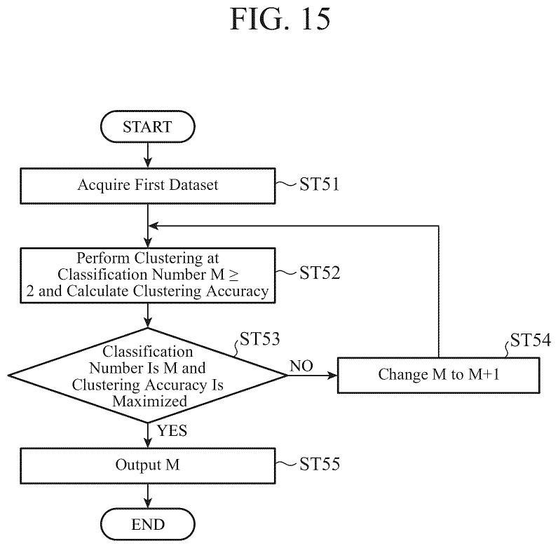

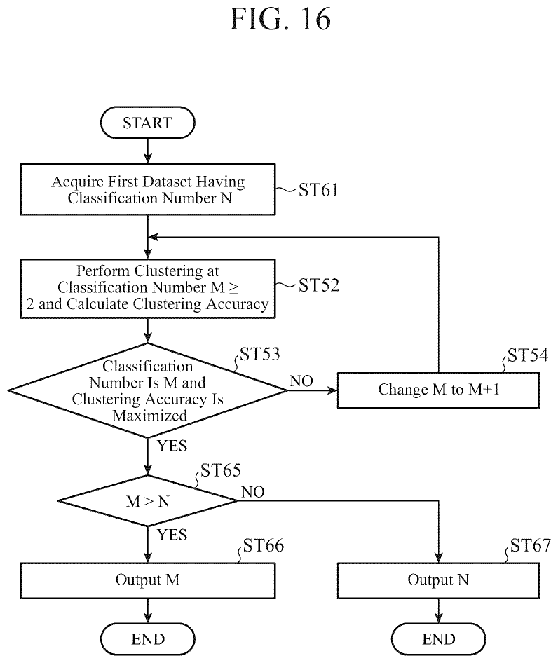

Therefore, as illustrated in FIG. 15, if the number of clusters is unknown (step ST51), calculation is performed from an integer of 2 or more. If the classification number N can be estimated from an empirical rule or the like (step ST61), as illustrated in FIG. 16, when M is equal to or less than N, M=N is set (step ST67). Note that, in order to shorten a calculation time for searching for the optimum number of clusters, clustering is performed in a direction in which M increases from M=N (step ST52), a value of M is increased one by one such as M+1 and M+2, and verifies an inference value with a target index such as clustering accuracy. Then, M in a case where the inference value with the target index is maximized is output (step ST55 and step ST66). Note that, in order to prove that M is maximized, the case of M+1 needs to be calculated, and thus at least the case of M+1 needs to be calculated.

### <Experimental Results>

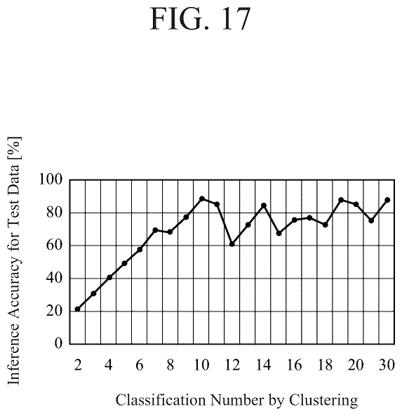

FIG. 17 illustrates a result of taking the number of clusters on the horizontal axis, performing M-value classification as a target index in the present embodiment, assigning data in which labels are assigned to the M values to training data and test data at a ratio of 80:20, performing training with the training data, and taking inference results in a case of inference with the test data on the vertical axis. As illustrated in FIG. 17, it is found that the inference accuracy for the test data created by clustering increases monotonically up to the number of clusters of 10. When the number of clusters is 11, the accuracy decreases by about 1%, and therefore it is found that the inference accuracy for the test data is maximized when the number of clusters is 10. As the number of clusters is further increased, it is found that the inference accuracy in a case of the number of clusters of 13 or 18 is almost the same as that in the case of the number of clusters of 10. Although a plurality of maxima appears, the number 10 which is the minimum number of clusters is selected.

Since it is possible to calculate the optimum number of clusters by a similar method even for a problem whose classification number is unknown, even when data cannot be treated as a classification problem because the classification number thereof is unknown, it is possible to give a new label by clustering and to convert the data into test data with the label.

### <Utilization of Dissimilar Data>

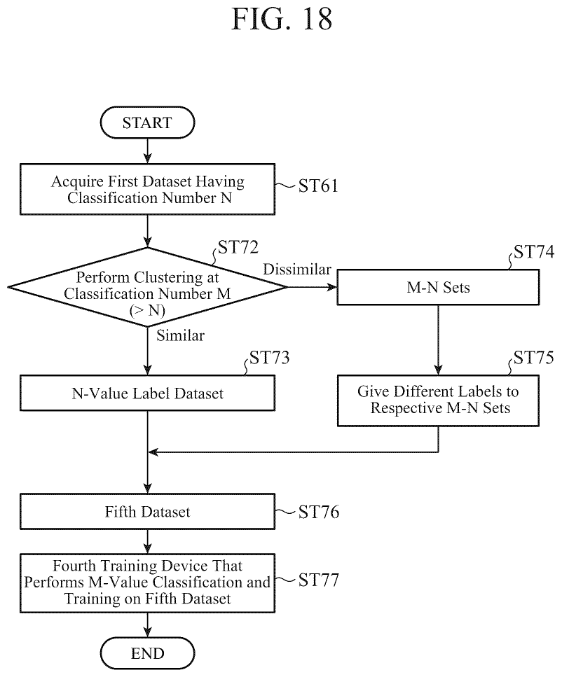

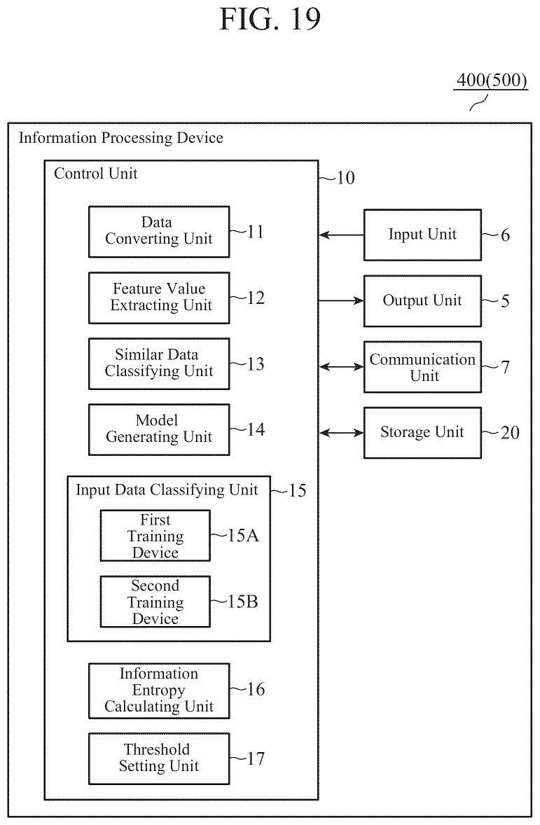

FIG. 18 illustrates a flowchart in a case where inference is performed by giving a new label to data determined to be dissimilar by clustering as in the second embodiment. As described above, in a case of M>N, the first dataset is classified into M values by clustering (step ST72), a new label is given to each piece of similar data, and a dataset is obtained (step ST73). In addition, one dataset (unclassified dataset) is created from dissimilar data, a new label (second label) is given (step ST74 and step ST75), M-value classification dataset is combined with non-classification dataset, and a fifth dataset is constituted (step ST76). Then, a fourth training device that performs training by using the fifth dataset as M+1-value classification may be constituted (step ST77). Note that the information processing device 300 may use a sixth dataset that is different from the first dataset and does not have a correct answer label as the input data in the similar data classifying unit.

As a result, even to data that cannot be treated as a classification problem because the classification number thereof is unknown, a new label can be given, and the data can be used to train. In addition, by adding a new label to dissimilar data, it is possible to constitute a training device capable of determining an abnormal value as an outlier by the method described in the second embodiment.

### Fourth Embodiment

### <Overview>

For an output in each of the training devices described in the first to third embodiments, a probability of an inference result can be calculated by a concept of information entropy.

### <Information Entropy>

In an information processing device 400 according to the present embodiment, a control unit 10 further includes an information entropy calculating unit 16 and a threshold setting unit 17 as compared with the information processing device 100 according to the first embodiment. The information processing device 400 according to the present embodiment is based on a finding of an effect that information entropy is smaller as a result has higher inference accuracy. For example, in VGG13 of the first to third embodiments, outputs of a softmax function in a case where an inference result is a correct answer and outputs of the softmax function in a case where the inference result is an incorrect answer are sorted in descending order, and an addition average is taken. Results thereof are as follows.

In a case of correct answer
[0.937, 0.05, 0.01, 0.003, 0.0012, 0.00051, 0.00022, 0.0001, 0.00005, 0.00002]

In a case of incorrect answer
[0.702, 0.207, 0.0563, 0.021, 0.0079, 0.0032, 0.0013, 0.00065, 0.00032, 0.00015]

In this case, also in the training devices described in the first to third embodiments, similarly to a general training device, a label corresponding to a value at which the softmax function outputs the largest output is output as an inference candidate. However, this processing is the same processing although there is a clear difference between 0.937 in a case where it is determined as a correct answer and 0.702 in a case where it is determined as an incorrect answer, and in a case of an incorrect answer, it can be considered that information of candidates other than the inference candidates is discarded. That is, in a general training device, although another inference candidate is also listed as a candidate in a case of an incorrect answer, it can be considered that the information is discarded.

Note that, since a total value of the outputs of the softmax function is normalized to be 1, the output of the softmax function can be handled as a probability (probability of inference and inference value) that the inference is a correct answer, and any training device as well as VGG13 can perform evaluation with the same index by using the softmax function immediately before an output layer. Note that, since the softmax function is a function expressed by an exponential function, an output thereof tends to be a large difference, and it is also desirable to perform normalization by a method other than the exponential function such as the softmax function at the time of inference.

The information entropy calculating unit 16 calculates information entropy with respect to an average value of the outputs of the softmax function in the case of a correct answer and an average of the outputs of the softmax function in the case of the incorrect answer, whereby information entropy can be calculated under each condition. The information entropy in the case of the correct answer is smaller than the information entropy in the case of the incorrect answer also in the above average values.

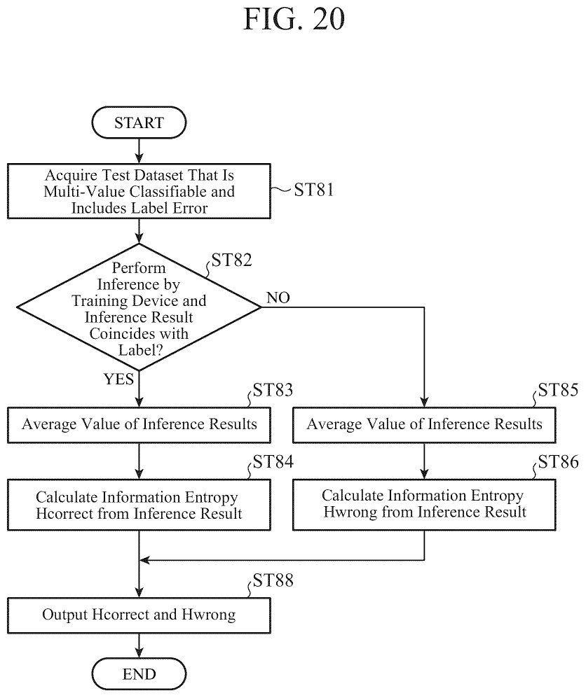

FIG. 20 illustrates a flowchart of processing (step ST83 and step ST85) of calculating an addition average of inference values in a case of a correct answer and an addition average of inference values in a case of an incorrect answer at the time of inference after acquiring a test dataset that is multi-value classifiable and includes a label error (step ST81), and processing (step ST84, step ST86, and step ST88) of calculating H_correct (first information entropy) that is information entropy in a case where inference is a correct answer (YES in step ST82) and H_wrong (second information entropy) that is information entropy in a case where the inference is an incorrect answer (NO in step ST82) from the corresponding one of the addition averages by an information entropy equation. In this way, a probability of inference can be calculated on the basis of information entropy when an inference result is obtained.

### <Threshold>

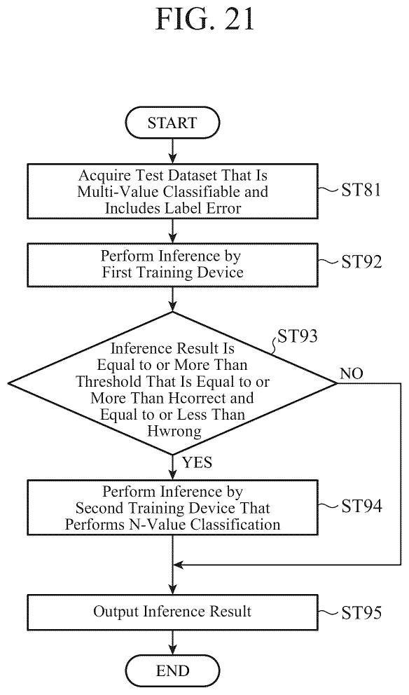

FIG. 21 illustrates a flowchart of processing of performing inference on the basis of a threshold set by the threshold setting unit 17 on the basis of the information entropy obtained in FIG. 20. In FIG. 21, inference is performed on test data by the first training device (step ST92), and if an output result of the softmax function of the inference result is larger than the information entropy as the threshold (YES in step ST93), the second training device that performs N-value classification is used (step ST94 and step ST95). Note that the second training device does not necessarily need to be used, and a training device trained with the first dataset or a training device trained with the third dataset using an algorithm different from that of the first training device may be used.

At this time, although setting of the threshold is a parameter, it is desirable to set a threshold between H_correct and H_wrong. This is because a value smaller than H_correct is less likely to be an incorrect answer, a value larger than H_wrong is more likely to be an incorrect answer, but the number of pieces of data assigned to H_wrong is small, and it is less likely to improve inference performance. This indicates that inference accuracy can be improved by outputting a result of inference by the first training device through such processing, the result being considered to have small information entropy and a high probability, and outputting a result of inference by a different training device, the result being considered to have large information entropy and a low probability.

<Training Device that Determines Threshold>

In a training device that determines a threshold, in a case where the training device trained with the first dataset is used instead of the first training device, in a case of a dataset having a small number of label errors, a result in which information entropy is relatively small tends to be obtained, a width between H_correct and H_wrong is also small, and a high inference result can be obtained.

In a case where a training device trained with the second dataset is used instead of the first training device, since the data is data obtained by removing a label error, in a case where there are many abnormal values in test data, information entropy tends to be large, but in a case where it is assumed that there are few abnormal values in the test data, a high inference result can be obtained. In a case where a training device trained with the fourth dataset is used instead of the first training device, in a case where it is assumed that there are many abnormal values in test data, a high inference result can be obtained.

<Model for Input Data Equal to or More than Threshold>

Also in a case where the data is equal to or more than the threshold in FIG. 21, the second training device does not necessarily need to be used, and inference may be performed by a training device that has performed training using the first, third, or fourth dataset as described in the above <Training device that determines threshold>.

As described in <Deformation of input data as outlier> in the second embodiment, in a case where information entropy is equal to or more than the threshold, deformation may be performed until the information entropy becomes a value equal to or less than the threshold, and a label whose information entropy is equal to or less than the threshold may be output as an inference value. Furthermore, the way of deformation may be changed depending on an inference candidate. For example, in a case where the inference candidate is determined to be an apple, it is necessary to recognize the inference candidate as an apple even when the apple is rotated because the apple is close to a circle. Meanwhile, in a case where the inference candidate is determined to be an automobile, it is not realistic to reverse the automobile by 90 degrees, and thus, it is expected that a rotation angle is about ±10 degrees at the maximum. As described above, the inference accuracy can be improved by performing deformation in accordance with an actual condition.

<Another Model is Used for Input Data Equal to or More than Threshold Until Input Data Becomes a Value Equal to or Less than Threshold>

For the result of the threshold determination, a fifth training device constituted by a plurality of training devices different from the first training device may be constructed, and the training device may repeatedly perform inference until a value equal to or less than the threshold is output for input data equal to or more than the threshold. Note that, since there is a case where convergence does not occur depending on input data, in this case, in a case where determination cannot be made even when inference is performed by all the training devices, a fact that determination cannot be made is output, determination is made by majority decision of output results of the plurality of training devices in the fifth training device, and an inference value is output on the basis of an inference result of a training device that has output minimum information entropy among the plurality of training devices in the fifth training device.

### Fifth Embodiment

### <Overview>

When the information entropy described in the fourth embodiment is used, existing ensemble inference can be efficiently performed. In the ensemble inference, two or more training devices that have separately performed training for the same dataset are prepared, inference is performed on one piece of input data by the above different training devices, and a sum or majority decision of the inference results is taken as an inference result. However, there is generally a difference in inference accuracy for input data between different training devices. On the other hand, the present embodiment indicates that the inference accuracy can be improved by adding a larger weight as the inference accuracy is higher, and taking a sum thereof.

### <Ensemble Inference>

The ensemble inference takes a sum of results of a plurality of inference results, and in the present embodiment, Resnet18 and Densenet121 are used for the ensemble inference in addition to VGG13. Note that, although the ensemble inference may use a softmax function, since normalization is performed and processing is performed by an exponential function when the softmax function is used, there is a tendency to depend on a specific inference result (for example, VGG13), and inference accuracy is less likely to be improved.

On the other hand, with a result of outputting 10-value classification by full connection before applying the softmax function, high inference accuracy can be obtained. An average value of inference results before softmax for 10,000 pieces of test data of CIFAR-10 of each of the VGG13, the Resnet18, and the Densenet121 will be described.

VGG13 is
[6.033, 1.100, 0.5481, 0.2501, −0.0525, −0.3022, −0.594, −1.216, −2.329, −3.436]

Resnet18 is
[5.507, 0.318, −0.265, −0.492, −0.619, −0.746, −0.839, −0.917, −0.953, −0.993]

Densenet121 is
[5.004, 0.07, −0.369, −0.495, −0.568, −0.647, −0.704, −0.748, −0.767, −0.784]

Next, an average value of output results in a case of a correct answer will be described below.

VGG13 is
[6.199, 1.015, 0.5345, 0.2569, −0.0423, −0.2905, −0581, −1.219, −2.37, −3.50]

Resnet18 is
[5.616, 0.2178, −0.3013, −0.5036, −0.6195, −0.7430, −0.8329, −0.9088, −0.9428, −0.9815]

Densenet121 is
[5.070, 0.007, −0.385, −0.497, −0.5673, −0.645, −0.700, −0.7425, −0.761, −0.778]

Next, an average value of output results in a case of an incorrect answer will be described below.

VGG13 is
[4.003, 2.1348, 0.7128, 0.1674, −0.1769, −0.444, −0.754, −1.181, −1.805, −2.656]

Resnet18 is
[4.044, 1.666, 0.217, −0.337, −0.614, −0.7903, −0.920, −1.030, −1.089, −1.146]

Densenet121 is
[3.953, 1.222, −0.1148, −0.469, −0.583, −0.675, −0.766, −0.831, −0.855, −0.880]

This result indicates that the larger a value is, the larger a probability is, and the more negative a value is, the farther the value is from prediction. Therefore, a general training device outputs an inference value corresponding to a maximum value.

As described above, by calculating an average value of the inference results, information entropy with respect to the average value can be calculated. Furthermore, in the average value, maximum values in the three training devices are close to each other regardless of a case of correct answer or a case of an incorrect answer, and therefore it is difficult to depend on any one inference result as in the case of applying the softmax function. Note that, in the above example, values of information entropy of the average value are 1.1, 0.90, and 0.83 for VGG13, Resnet18, and Densenet121, respectively.

Next, inference results for test data in the training devices are 92.39%, 93.07%, and 94.06% for VGG13, Resnet18, and Densenet121, respectively. From this result, it is found that Densenet121, Resnet18, and VGG13 are in descending order of inference accuracy. Similarly, it is found that Densenet121, Resnet18, and VGG13 are in ascending order of information entropy. From this, it can be confirmed that the information entropy tends to be smaller as the training device has higher inference accuracy. This tendency is similarly confirmed also when verification is performed using different datasets or different training devices. Therefore, when information entropy is used as a weight, accuracy of ensemble inference can be improved.

### <Utilization of Information Entropy in Ensemble Training>

When a sum of the inference results of Densenet121, Resnet18, and VGG13 was taken and compared with a correct answer label, inference accuracy was 94.59%. On the other hand, since the information entropy is smaller as the training device has higher inference accuracy, the inference accuracy can be improved by using a weight including a reciprocal of the information entropy in a function. That is, on the basis of a function f(⋅), when the information entropy of VGG13 is represented by entropy 1, the information entropy of Resnet18 is represented by entropy 2, and the information entropy of Densenet121 is represented by entropy 3, the inference accuracy can be improved by calculation with

$$f ( 1 / entropy 1 ) * VGG 13 + f ( 1 / entropy 2 ) * Resnet 18 + f ( 1 / entropy 3 ) * Densenet 121.$$

As an example, in a case where f(⋅) is an identity mapping, f(x)=x. Therefore, calculation can be performed with

$$( 1 / entropy 1 ) * VGG 13 + ( 1 / entropy 2 ) * Resnet 18 + ( 1 / entropy 3 ) * Densenet 121.$$

When the ensemble inference is performed on the basis of this equation, the inference accuracy of information entropy is 94.65%, which is higher by 0.06% than 94.59% of the ensemble inference. Note that, in a case where a sum is taken without applying the weight after applying the softmax function, the inference accuracy is 94.39%, which is lower by 0.2% than 94.59% of the comparison target.

### <Algorithm of Ensemble Inference Using Information Entropy>

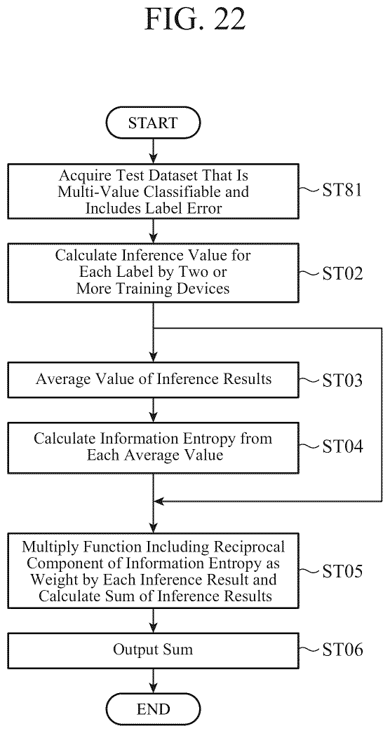

FIG. 22 illustrates a flowchart of ensemble inference. Two or more information processing devices perform inference on test data that is multi-value classifiable, such as the first dataset (step ST81), and two or more inference results are output (step ST02). Then, information entropy is calculated from an average value of the output results (step ST03 and step ST04), the output result of each training device is multiplied by a function including a reciprocal of the information entropy as a component as a weight, and then a sum is taken (step ST05 and step ST06), whereby ensemble inference using the information entropy can be constituted.

Although improvement of the inference accuracy is small, there is an effect that the inference accuracy can be improved by simple calculation. In addition, in a case where high inference accuracy is required, for example, inference may be performed by combining ten or more training devices, but there is also a training device that works in a direction of deteriorating the inference accuracy depending on a training device to be incorporated. Conventionally, optimization is performed by performing training with human empirical rules, parameters of many weights, and full connection connecting training devices, but this can be processed by a method based on information entropy, and thus optimization is unnecessary. In addition, also in a case where a weight is optimized by obtaining higher inference accuracy, an optimization problem can be solved from a value close to an optimum value, and therefore the optimum value of the weight of each training device can be obtained with a small number of times of calculation.

Note that the present disclosure can freely combine the embodiments to each other, modify any constituent element in each of the embodiments, or omit any constituent element in each of the embodiments.

### INDUSTRIAL APPLICABILITY

The information processing device according to the present disclosure can be used for classifying input data.

### REFERENCE SIGNS LIST

11: data converting unit, 12: feature value extracting unit, 13: similar data classifying unit, 14: model generating unit, 15: input data classifying unit, 16: information entropy calculating unit, 100, 200, 300, 400, 500: information processing device

1. An information processing device comprising:
a processor; and
a memory storing a program, upon executed by the processor, to perform a process:
to extract a feature value of input data;
to classify, on a basis of a first dataset including a plurality of pieces of input data and the feature value extracted for each of the plurality of pieces of input data included in the first dataset, some or all of the plurality of pieces of input data included in the first dataset into N datasets including a plurality of pieces of input data having similar feature values and to newly give N different labels to the respective N datasets, in which N represents a specific integer of two or more;
to generate, using a part of each of the N datasets, a trained model for classifying input data in such a manner as to correspond to any one of labels given to the respective N datasets; and
to classify input data by inference based on a trained model generated, wherein
the process defines a fifth dataset including N correct answer labels on a basis of inference accuracy when the process classifies, by inference based on the trained model generated, input data not used for generation of the trained model among the N datasets.

2. The information processing device according to claim 1, wherein
the first dataset includes M correct answer labels and a plurality of pieces of input data associated with the respective M correct answer labels, in which M represents a specific integer of two or more, and
the process defines, as the fifth dataset, the minimum N that is equal to or more than the M and has maximum inference accuracy with respect to a classification number.

3. The information processing device according to claim 1, wherein
the process uses a sixth dataset that is different from the first dataset and does not have a correct answer label as input data.

4. The information processing device according to claim 1, wherein
when input data that is not classified as the fifth dataset among the plurality of pieces of input data included in the first dataset is defined as an unclassified dataset, the process gives, to the unclassified dataset, a second label different from labels given to the respective fifth datasets, and
the process generates, using the fifth dataset and the unclassified dataset, a fourth trained model that is a trained model for classifying input data in such a manner as to correspond to any one of the labels given to the respective fifth datasets and the second label.
